(19) United States
(12) Patent Application Publication
(10) Pub. No.: US 2003/0142958 A1
(43) Pub. Date: Jul. 31, 2003

(54) Broadcast recording method, device, and recording medium

(76) Inventors: Toshaki Matsunaga, Kanagawa (JP); Kato Kouichi, Kanagawa (JP)

Correspondence Address: WILLIAM COLLARD, COLLARD & ROE, P.C., 1077 NORTHERN BOULEVARD, ROSLYN, NY, 11576, US

(21) Appl. No.: 10/297,531

(22) PCT Filed: Jun. 5, 2001
(86) PCT No.: PCT/JP01/04718

(30) Foreign Application Priority Data
Jun. 6, 2000 (JP) 2000168737

(51) Int. Cl. H04N 5/76; G06F 3/00; G06F 13/00

(52) U.S. Cl. 386/93; 725/58

(57) ABSTRACT

A broadcast recording method and a device are provided which can record an extended TV program or a TV program which is moved back due to the extended previous TV program. The method and the device obtain broadcast information including a start time and an end time of a program, and start times and end times of commercial broadcast parts and news broadcast parts, via a network or the like. And the method and the device edits recorded digital broadcast data based on the broadcast information and records the edited broadcast data. The broadcast information may include an identifier representing whether the commercial broadcast parts and the news broadcast parts are to be deleted or not, and information representing a location where these broadcast parts are moved to. These broadcast parts are deleted or moved based on the broadcast information.

### TECHNICAL FIELD

The invention relates to a method and a device for recording a broadcast, in particular, to a method and a device which can successfully record a moved back TV program, and record a TV program deleting a unnecessary part of the program for a user.

### BACKGROUND ART

Nowadays, a video tape recorder (VTR or video cassette tape recorder (VCR)) has spread over most of families. The VTR has been used to record a desirable TV program on a video tape (or video cassette tape) and reproduce (play back) the TV program when a user wants to watch the TV program.

In our time, since both children and adults are leading very busy life, it is often that they cannot directly watch a live broadcast TV program. However, if the TV program is recorded on the video tape by the VTR, they can watch the TV program in a free time by reproducing the recorded TV program and this supplies a large convenience to them. In this point of view, the VTR is indispensable for the present life-style.

Further, in the VTR, a timer recording function is added to provide a further convenience. This function automatically starts, when a recording start time, a recording end time, and a TV channel to be recorded are previously designated, recording of a TV program of the designated channel from the designated recording start time. Thereby, even if a user leaves a home, the user can record a desirable TV program.

However, when the VTR records a TV program in a conventional manner, in particular, when the recording is carried out by using the above-mentioned timer recording function, there are many problems as follows.

The first problem is that if recording of a TV program is carried out by the conventional type of VTR, it is not able to successfully record the TV program when a broadcast of the TV program is extended, or is moved back due to the previous extended TV program.

For example, a broadcast of a baseball game or a football game does not always end at a fixed time, therefore, when the timer recording function is used, a problem comes up that what time is to be designated as a recording end time. Further, an actual broadcast start time of the TV program which is moved back due to thus extended previous TV program, is also changed as well as an actual broadcast end time. A corrective measures for completely recording the extended or moved back TV program is to record a broadcast all over a “possible” time zone when the desirable TV program may be broadcast. For instance, if a user wants to record a broadcast of a baseball game, it is required that a predetermined broadcast start time is designated as a recording start time, and a latest broadcast end time which is predetermined as the latest time when the baseball game is extended is designated as a recording end time.

If a user wants to record the next TV program following the broadcast of the baseball game, it is required that a fastest broadcast start time which is a predetermined broadcast start time if there is no extension of the previous TV program is designated as a recording start time, and a latest broadcast time which is predetermined as the latest time when the broadcast of the baseball game is extended to a limit time is designated as a recording end time.

Thus, if timer recording settings for the “possible” time zone is not done, recording of the broadcast of the baseball game or the next TV program is suspended on the way when the broadcast of the baseball game is extended. This can happen not only in a case of sports live relay broadcast such as the broadcast of the baseball game but also in a case where an event suddenly happens or a special program for someone's sudden death is inserted.

Also, if there is a video (cassette) tape including an hour empty part and a user wants to record an hour TV drama provided after the broadcast of the baseball game on the empty part of the video tame by using the timer recording function, there is no way but praying for early ending of the baseball game.

Therefore, recording of a TV program may end on the way, or a new video tape must be used to record a TV program in spite of a presence of an enough empty space in a video tape being used. These cause a degradation of efficiency of using video tapes and a confusion for management of recorded contents or titles of the contents.

However, it is not practical that a user stands by beside the VTR all the time to manipulate the VTR and eliminate the degradation of efficiency.

The second problem is that it is not able to delete or separate commercial broadcast parts or news broadcast parts included in a TV program from a recorded TV program since time zones when the parts are inserted in the TV program are not known in advance. In general, an hour of TV program in which commercial broadcast parts and news broadcast parts are inserted includes only about a forty minutes of main broadcast part (net program part).

It is desirable to watch the recorded TV program skipping the commercial broadcast parts and the news broadcast parts (or collectively watching the parts later) when a user is busy. In that case, even if it takes three hours to watch three dramas each of which includes an hour of contents, in an original live broadcast, it is capable of watching whole the three dramas in about two hours by using a reproduction of a VTR.

Further, if the commercial broadcast parts and the news broadcast parts can be separated and deleted, or moved to the latter part, a user can watch a drama continuously (without interruption). Still further, if the commercial broadcast parts and the news broadcast parts can be excluded from the original TV program and the rest parts of TV program can be recorded, video tapes are effectively used and a management of recorded contents or titles of the contents can be easier.

Reflecting the needs, in recently years, various VTRs including a CM(commercial)-cut function are available. But, this function automatically determines that broadcast parts provided with non-stereo sound are main broadcast parts based on the fact that commercial broadcast parts are provided with a stereo sound, and cuts the determined commercial broadcast parts and then, records the main broadcast parts. Therefore, this function does not satisfy user's actual demands if the whole TV program is broadcast with a stereo sound, or broadcast of the TV program is moved back.

Various methods of identifying commercial parts by using contents of signals of TV broadcast (for example, a sound mode such as a stereo sound or a double sound), are proposed. An example of the method is disclosed in Japanese Laid-Open Publication No. H11-296930 which is entitled “automatic recording device”.

Further, as disclosed in Japanese Laid-Open Publication No. H11-127411, “recording device and recording method”, a method is proposed which memorizes a characteristic image frame, and determines that a TV program is commenced when an image frame appears which is the same as the memorized image frame.

Namely, in these conventional devices and methods, determination is carried out based on signals of a TV broadcast. Therefore, as long as the determination criteria are used, it is not possible to completely determine start times and end times of the commercial broadcast parts, the news broadcast parts, and the main broadcast parts. Also, if standards or contents of TV broadcast is changed, these conventional devices and methods cannot serve fully.

The third problem is that while a VTR records a TV program by using a timer recording function, the VTR cannot reproduce the TV program being recorded from the beginning. For example, in a case where a user comes home while a TV program of a baseball game is recorded by the timer recording function and the user demands to watch the TV program from the beginning not from the time point when the user reaches the home, the user is required to wait for an end time designated for the timer recording function, rewind a video tape, and reproduce the video tape to watch the baseball game from the beginning.

Many of baseball fans and football fans want to watch a game from the beginning as possible, not to simply know a result of the game or not to watch the game from on the way. However, in the conventional VTR, only after the VTR records until the end of the game, the VTR can reproduce the video tape.

A function that while recording a TV program, reproduction of the TV program can be carried out from the beginning will be realized in the near feature as spreading digital recording devices to the general public. If such the reproduction can be available and the commercial broadcast parts and the news broadcast parts are deleted, a TV program reproduced may catch up with a live original TV program when the reproduction is carried out from the beginning of the recorded TV program.

However, at the present time, there is no VTR and no software which provide such the function.

Therefore, it is an object of the invention to provide a method and a device which can successfully record a TV program taking into account an extension of a TV program and a movement of the next TV program due to the extension of the previous TV program.

Further, it is another object of the invention to provide a method and a device which can record a TV program so that commercial broadcast parts or news broadcast parts included in the TV program are deleted or separated from the TV program.

Still further, it is an object of the invention to provide a method and a device which reproduce a recorded TV program from the beginning of the TV program, while recording of the TV program is carried out.

Also, a method and a device of the invention can be applied to recording of a radio broadcast or a broadcast through the Internet as well as the recording of a TV program.

### DISCLOSURE OF THE INVENTION

A broadcast recording method and a broadcast recording device of the invention obtain information including a start time and an end time of a program, and a plurality of pairs of a start time and an end time of commercial broadcast parts or news broadcast parts, from a predetermined location through a network. Then the method and the device edit recorded digital broadcast data based on the obtained information and record the edited digital broadcast data. The edited and recorded broadcast data can be reproduced even if the rest part of the program is still recorded.

There are two backgrounds related to this invention.

First, a growth of a network environment such as the Internet is listed. Using the Internet, most of users, at a home, can easily obtain the information including the start time and the end time of the program and the like, in almost real-time.

Second, a growth of a technology in recent years is listed. A mass storage recording device (recording medium) which is indispensable for digital editing or recording and is capable of high speed access, has been available for a personal computer or the like at a low price. For example, in digital editing or recording of broadcast data, a part of or all of a semiconductor memory, a hard disk, a DVD-RW, a DVD-RAM and the like can be used. Also, a combination of some of the recording mediums can be used. In recent years, a personal computer is supplied which can record a TV program into a hard disk or the like.

At the present time, a personal computer can record a TV program by using a 256 M-512 M bytes of semiconductor memory, a 70 G bytes of hard disk, and a DVD-RW or DVD-RAM each of which has about 5.2 G bytes capacity in double sides.

According to a first aspect of the invention, a broadcast recording method is provided. The method comprises the steps of receiving a broadcast, receiving broadcast information which includes a start time and an end time related to at least one broadcast part of a plurality of broadcast parts in the broadcast, editing the received broadcast by using the broadcast information, and recording the edited broadcast. Thereby, a user can instruct to record only desirable parts of TV programs.

According to a second aspect of the invention, the broadcast recording method of the first aspect is provided which further comprises the steps of generating the broadcast information, and providing the broadcast information.

According to a third aspect of the invention, the broadcast recording method of the second aspect is provided in which the generating step generates the broadcast information based on actual results of the broadcast.

According to a fourth aspect of the invention, the broadcast recording method of the third aspect is provided in which the actual results of the broadcast are provided by a watching agent.

According to a fifth aspect of the invention, the broadcast recording method of the first aspect is provided in which the editing step edits the received broadcast so that a broadcast part specified by a pair of times, the start time and the end time, included in the broadcast information is kept, or the broadcast part is deleted.

According to a sixth aspect of the invention, the broadcast recording method of the first aspect is provided in which the broadcast information further includes locating information comprising an identifier representing whether each broadcast part is to be kept or not, and an order of being recorded, and in which the editing step edits so as to rearrange each broadcast part based on the locating information.

According to a seventh aspect of the invention, the broadcast recording method of the sixth aspect is provided in which the locating information is provided based on at least one request of a broadcast advertisement provider.

According to an eighth aspect of the invention, the broadcast recording method of the first aspect is provided which further comprises a step of reproducing the recorded broadcast.

According to a ninth aspect of the invention, the broadcast recording method of the eighth aspect is provided in which the reproducing step is executed simultaneously with the step of recording the edited broadcast.

According to a tenth aspect of the invention, a method of providing information related to a broadcast. The method comprises the steps of generating broadcast information which includes a start time and an end time related to at least one broadcast part of a plurality of broadcast parts in the broadcast, and providing the broadcast information. Thereby, small size of information representing necessary parts of a broadcast can be supplied to each home, and a user can reproduce and watch only desirable broadcast parts by using the information.

According to an eleventh aspect of the invention, the broadcast recording method of the second aspect is provided in which the broadcast information further includes additional information including at least one of a still image, a dynamic image, and a voice, and in which the editing step edits so that the additional information is added to the broadcast.

According to a twelfth aspect of the invention, a broadcast recording device is provided. The device comprises a broadcast receiving unit which receives a broadcast, a broadcast information receiving unit which receives broadcast information which includes a start time and an end time related to at least one broadcast part of a plurality of broadcast parts in the broadcast, an editing unit which edits the received broadcast by using the broadcast information, and a recording unit which records the edited broadcast.

According to a thirteenth aspect of the invention, a broadcast information providing device is provided. The device comprises a generating unit which generates broadcast information which includes a start time and an end time related to at least one broadcast part of a plurality of broadcast parts in the broadcast, and a providing unit which provides the broadcast information.

According to a fourteenth aspect of the invention, a computer readable recording medium storing a program performing a method of recording broadcast is provided. The program comprises the steps of receiving a broadcast, receiving broadcast information which includes a start time and an end time related to at least one broadcast part of a plurality of broadcast parts in the broadcast, editing the received broadcast by using the broadcast information, and recording the edited broadcast.

According to a fifteenth aspect of the invention, a computer readable recording medium storing a program performing a method of providing information related to broadcast is provided. The program comprises the steps of generating broadcast information which includes a start time and an end time related to at least one broadcast part of a plurality of broadcast parts in the broadcast, and providing the broadcast information.

### BRIEF DESCRIPTION OF THE DRAWINGS

FIG. 1 schematically shows a broadcast recording system of an embodiment of the invention.

FIG. 2 shows a hardware structure of a broadcast recording device of an embodiment of the invention.

FIG. 3 shows a functional block diagram of a broadcast recording system of an embodiment of the invention.

FIG. 4 shows a structure and contents of program time information of an embodiment of the invention.

FIGS. 5A and 5B show diagrams representing broadcast data editing processes of an embodiment of the invention.

FIG. 6 shows a flowchart of a broadcast data editing process of an embodiment of the invention.

### BEST MODE FOR EMBODYING THE INVENTION

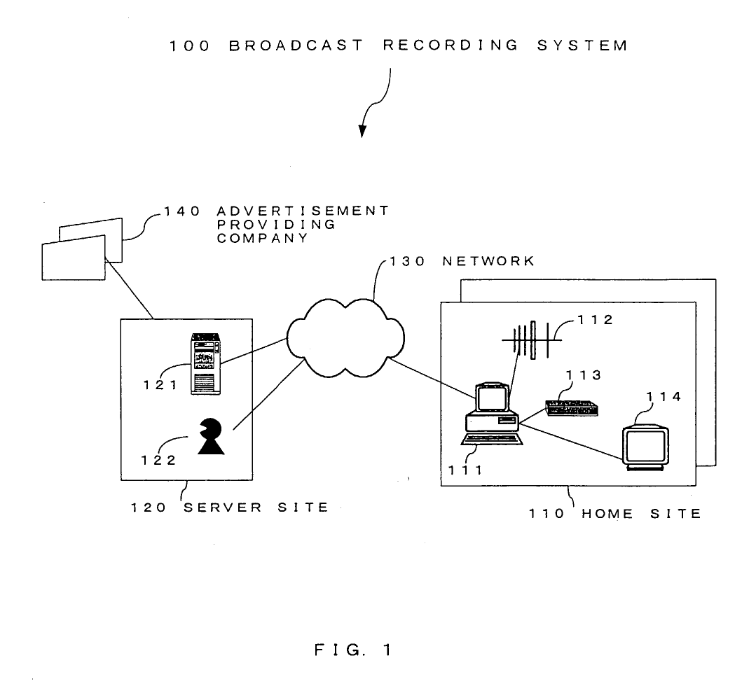

First, referring to FIG. 1, a description is made about a structure of an embodiment of the invention. Also, the structure shown in FIG. 1 is only used to illustrate the invention, therefore, various aspects using other methods can be thought of.

A broadcast recording system of the invention includes, as shown in FIG. 1, a broadcast recording device 111 located in a home site 110, a server 121 located in a server site 120, and a network 130 connecting the both sites 110 and 120. They are main elements of the invention. Herein, the home site 110 means a place where a user watches television, such as a user's home or the like. The server site 120 means a specific place or a plurality places where broadcast information about a TV broadcast is collected and managed uniformly.

The broadcast recording device 111 performs a digital editing process on a TV broadcast received from an antenna or the like based on the broadcast information received from the server 121, and records the edited data into a recording medium such as a hard disk as broadcast data. In general, a personal computer serves as the broadcast recording device 111. A detailed description about a structure of the broadcast recording device 111 will be made later.

The broadcast recording device 111 is connected to the above-mentioned antenna 112 to receive the TV broadcast, however, the device 111 can be connected to other object depending on a sort of broadcast to be received. For example, if the broadcast to be received is a broadcast provided through a satellite, the device 111 is connected to a parabolic antenna or the like, and if the broadcast is provided through a cable TV station, the device 111 is connected to a cable from the cable TV station. Also, if a broadcast is received through the Internet, the device is connected to the Internet. Of course, there are various connecting aspects for receiving each broadcast, a VTR, a STB(set top box), a modem, a network interface, or the like can be used. But, in this specification, descriptions about these connecting aspects are omitted.

Also, a sort of the broadcast is not limited to a TV broadcast including images. For example, the broadcast may include a voice-only broadcast such as a radio broadcast. However, in this specification, only a description about a TV broadcast received from a antenna through a ground wave is illustrated.

In addition, a VTR(VCR) 113 and a television monitor 114 can be included in the home site 110. The VTR 113 is connected to the broadcast recording device 111 to record broadcast data edited by the device 111 on a video tape (video cassette tape). It is desirable to record the edited broadcast data into a mass storage recording medium such as a hard disk, a DVD-RW, and a DVD-RAM, but, it is also possible to record them on the video cassette tape in a conventional manner.

A technology about such the mass storage recording medium has been grew up rapidly, and consequently, recording mediums having huge capacity and enabling high speed access are developed one after another, and are available in store.

In this embodiment, broadcast data are recorded into a DVD-RW, a DVD-RAM, or the like, but this is merely illustration. Therefore, in the invention, all the other available recording mediums can be used.

The television monitor 114 is used to display images of a TV broadcast and images of reproduced broadcast data. In FIG. 1, the monitor 114 is directly connected to the broadcast recording device 111, but the monitor 114 can be connected to the device 111 via the VTR. Also, the images can be displayed on a monitor, such as a CRT display device, of the broadcast recording device 111.

The server 121 collects a start time and an end time of a specific TV program, and start times and end times of commercial broadcast parts and news broadcast parts based on actual results of a broadcast. Then the server 121 supplies the above collected information (broadcast information) in response to a request from the broadcast recording device 111. In the broadcast information, in addition to the start time and the end time of the TV program, and the start times and the end times of the commercial broadcast parts and the news broadcast parts, information (identifier) about whether or not the commercial broadcast parts and the news broadcast parts are kept in the TV program, and information (order of being recorded) about, when the commercial broadcast parts and the news broadcast parts are kept in the TV program, where the broadcast parts are recorded are included.

Further, in the broadcast information, at least one of a still image, a dynamic image, and a voice can be included.

Hereinafter, in the broadcast information related to the specific program, information about a program part which have been already broadcast is referred to as program time information.

The server 121 is generally composed by a personal computer, and serves to send the program time information to the broadcast recording device 111 when receiving a request from the device 111.

In the server site 120, a plurality of watching agents 122 can be further included. Each of these watching agents 122 watches an actual live TV program, and informs the server 121 of a start time and an end time of the TV program, and start times and end times of commercial broadcast parts and news broadcast parts. Also, the watching agent 122 informs the server 121 of the time information, by using a web application via the Internet or by accessing through the Internet and a mobile phone.

In the embodiment, advertisement providing companies 140 can be included, which relate to the server site 120. Each of the companies 140 can control contents of the program time information so that a commercial broadcast part of own company, which is originally broadcast on the way of a TV program, is provided in an original time zone (namely, in a time zone between a start time and an end time of the TV program), on condition of a contract of payment a consideration.

When commercial broadcast parts and news broadcast parts are separated from main broadcast parts of a TV program, and the commercial broadcast parts and the news broadcast parts are gathered and recorded at a location behind an area which the main broadcast parts are recorded, an order of broadcast (a broadcast order in the gathered broadcast parts) of the commercial broadcast parts of own company can be designated in the program time information.

Also, the advertisement providing company 140 can insert commercial broadcast parts of own company into broadcast data by providing the broadcast information including the above-mentioned at least one of the still image, the dynamic image, and the voice, even if an original TV program includes no commercial broadcast part of the company.

The network 130 connects the broadcast recording device 111 in the home site 110 to the server 121 in the server site 120, and enables communicating information between both the devices. The Internet can be thought as a representative example of such the network. However, all topologies of network including LAN, MAN, WAN, intra-net, and extra-net, can be used.

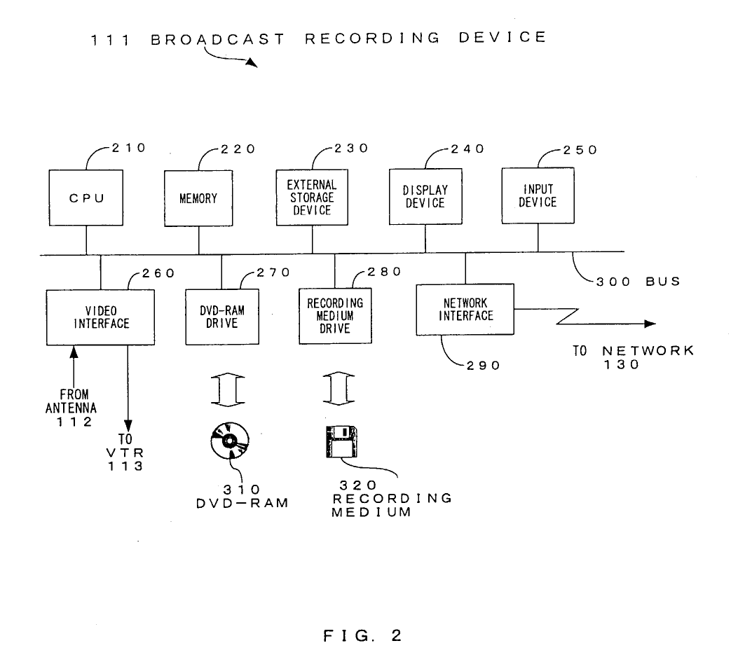

Next, referring to FIG. 2, a description is made about an example of a hardware structure of the broadcast recording device 111.

The broadcast recording device 111 shown in FIG. 2 includes a CPU 210, a memory 220, an external storage device 230, a display device 240, an input device 250, a video interface 260, a DVD-RAM drive 270, a recording medium drive 280, a network interface 290, and a bus 300 which connects the above elements each other.

The CPU 210 controls, based on instructions of an OS program or a user program, the above-mentioned elements in the broadcast recording device 111, and performs a process of transforming received TV broadcast signals into digital signals, a process of editing the digital signals based on program time information obtained from the server 121, and a process of recording the edited digital signals as broadcast data.

Into the memory 220, the OS program and the user program are loaded and the digital signals obtained from the TV broadcast are temporarily stored for a process of editing. The memory 220 is often composed of a semiconductor memory such as an SDRAM which is capable of accessing in a high speed, in a personal computer, a several hundred megabytes of memory can be embedded.

The external storage device 230 is generally composed of a single or a plurality of mass storage hard disks, several hundred gigabytes of data can be stored. Edited digital data, namely broadcast data are stored temporarily or for a predetermined period. Also, when capacity of the memory 220 is not enough, the device 230 is temporarily used, instead of the memory 220, to edit the digital signals.

The display device 240 is, in general, a CRT display connected to the broadcast recording device 111. Each instruction of a user is entered through a screen image displayed on the display device 240. Further, on the display device 240, images are displayed by using the transformed digital signals, and images are displayed by using the edited broadcast data. When the television monitor 114 is connected to the broadcast recording device 111, these images can be displayed on the television monitor 114 by performing a predetermined transformation on the digital signals.

The input device 250 is generally a keyboard or a mouse connected to the broadcast recording device 111 . A user uses the input device to enter required instructions in an instruction screen displayed on the display device 240. Entering these instructions, it is possible to instruct for obtaining a recording start time and a recording end time of a specific TV program, reproduction of broadcast data, or the like, but a detailed description is made hereinafter.

The video interface 260 is connected to the antenna 112 and the VTR 113. At the present time, NTSC signals are used for TV broadcast using a ground wave. However, it is required to transform the signals into a predetermined digital data form to enable to edit and record the signals in a digital manner. Therefore, if a TV broadcast signals are received via the antenna 112, the signals are transformed into digital signals such as MPEG-2 format. MPEG-2 is a representative recording format and is used to record a movie or the like into a DVD-ROM in a high image quality.

Even if the broadcast data are transformed into MPEG-2 format and edited, the data still can be recorded into the VTR 113. However, in this case, an opposite process to the above transformation, namely, a process to transform MPEG-2 format data into NTSC signal data is required. Although it is also possible to directly display images on the television monitor 114 from the video interface 260, a process to transform is required like the case of outputting to the VTR 113.

The process of transforming requires much CPU power, therefore there may be a video interface having a dedicated CPU.

The DVD-RAM drive 270 writes the edited broadcast data on a DVD-RAM 310, or reads out the recorded broadcast data from the DVD-RAM 310. In a conventional writable CD-ROM, 640 megabytes data can be stored at the most. Therefore, it is not suited for recording a long term TV broadcast. However, each of the DVD-RW and the DVD-RAM has 5.2 gigabytes capacity, consequently, it is possible to realize high quality image recording over two hours.

The recording medium drive 280 is used to access recording mediums other than the DVD-RW and the DVD-RAM (for instance, a floppy disk 320). These recording mediums generally do not have mass storage volume, therefore they are not used to record broadcast data. A user program which realizes a method of the invention is often stored in such the recording mediums, in this case, the program is read out by the drive 280 and loaded into the memory 220.

Also, when it is not required to immediately edit or reproduce a TV broadcast recorded as digital data, program time information received from the server 121 can be stored in such the recording mediums and distributed.

The network interface 290 is an interface to connect the broadcast recording device 111 to the network 130. Depending on a connecting aspect, there may be a case where a modem or a router is required, but in such the case, the network interface 290 is considered as including them. By using the interface 290, it is possible to exchange information in real-time between the broadcast recording device 111 and the server 121 through the network 130.

The bus 300 is a common transmission line of various data transmitted between the elements.

The server 121 also includes the elements of the broadcast recording device 111 as shown in FIG. 2. In the elements, the CPU 210, the memory 220, the external storage device 230, the network interface 290, and the bus 300 are indispensable for the server 121.

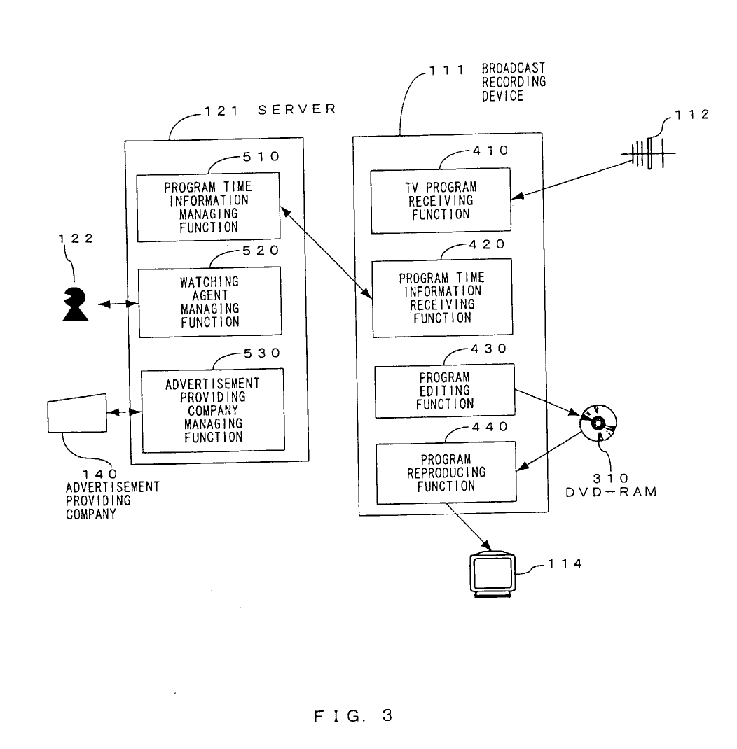

Then, referring to FIG. 3, a description is made about each function of the broadcast recording device 111 and the server 121.

The broadcast recording device 111 includes a TV broadcast receiving function 410, a program time information receiving function 420, a program editing function 430, and a program reproducing function 440.

The TV broadcast receiving function 410 receives a TV broadcast from the antenna 112 or the like, and transforms the received data into MPEG-2 format data so as to edit or record in a digital format. The transformed digital data are temporarily stored into a memory or a hard disk. At this time point, the stored digital data include original data which are actually broadcast. When a user wants to record a specific program, the user designates a start time and an end time of the program. Herein, the start time is the earliest time among possible candidates for the start time (earliest start time), the end time is the latest time among possible candidates for the end time (latest end time).

The earliest start time and the latest end time can be provided from the server 121. In this case, when the user designates a specific program and a broadcast date, the earliest start time and the latest end time are downloaded from the server 121 through the network 130, and then timer recording settings are automatically performed.

Therefore, the digital data temporarily stored in the memory or the hard disk by the function 410 include main broadcast parts of the program designated by the user, commercial broadcast parts and news broadcast parts inserted in the designated program, and other programs which is next to the designated program and the user do not want to watch (including commercial broadcast parts and news broadcast parts inserted in the next program).

The program time information receiving function 420 receives program time information of the program designated by the user from the server 121. The information includes, as described above, a start time and an end time of the program, start times and end times of commercial broadcast parts and news broadcast parts, information representing whether the commercial broadcast parts and the news broadcast parts are kept or not, and information representing a location where the commercial broadcast parts and the news broadcast parts are recorded if the parts are kept.

Since the program time information is provided from the server 121 based on actual results of broadcast of the designated program, if a part of the TV broadcast is temporarily recorded into the memory or the hard disk by the TV broadcast receiving function 410 and after a predetermined time period passes from the recording timing, the program time information corresponding to the recorded part is obtained.

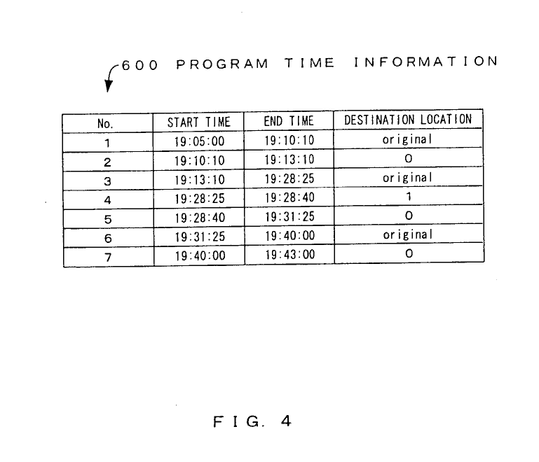

In FIG. 4, an example of program time information 600 is shown.

The program time information 600 includes items (a start time, an end time, and a destination location). Item No. is not indispensable, since it is added for convenience of explanation of each row. Each row corresponds to one of the main broadcast part, the commercial broadcast part, and the news broadcast part. And broadcast progresses from a broadcast part corresponding to the top row to a broadcast part corresponding to the bottom row as time goes by. The start time is a time point when a broadcast of the corresponding broadcast part is started, and the end time is a time point when a broadcast of the corresponding broadcast part is completed. Each of the start time and the end time is not required to be an absolute time. It may be a relative time which is relative to a certain time point, for example, a start time of a broadcast of a program.

In the item destination location, “original” is set when the corresponding broadcast part is to be kept without any change, “0” is set when the corresponding broadcast part is to be deleted, and a numerical number such as “1” or “2” is set when the corresponding broadcast part is to be moved behind a recording area of the main broadcast parts. The numerical number shows where the corresponding broadcast part is recorded in the latter part.

Since the corresponding broadcast part can be edited properly by referring to the contents of the information 600, it is no need to contain information representing whether each of broadcast parts is a main broadcast part, a commercial broadcast part, or a news broadcast part.

Returning to FIG. 3, the program editing function 430 edits the digital data temporarily stored by the TV receiving function 410 by using the program time information obtained by the program time information receiving function 420, generates the resulting broadcast data as the final broadcast data, and records the final broadcast data into a hard disk in the broadcast recording device 111, a DVD-RW, a DVD-RAM, a video cassette tape, or the like. A data structure of the program time information 600 shown in FIG. 4 is merely illustrated, and therefore a scope of the invention is not limited to such the data structure. As far as the program editing function 430 can edit the digital data properly, any structure of program time information may be provided.

Also, the server 121, as set forth, can provide information related to a still image, a dynamic image, and a voice with its insert location (the information is provided by, for example, an advertisement providing company), in addition to the program time information. The additional information is interpreted by the program editing function 430, as a result, the still image, the dynamic image, and the voice are inserted in the designated insert location. The images or the voice can be inserted so as to interrupt images and voice of an original broadcast, or to (partly) overlap with the images and the voice of the original broadcast.

The reproducing function 440 reproduces, in response to a user's instruction, the final broadcast data generated by the program editing function 430 on the display device 240 (CRT monitor or the like) connected to the broadcast recording device 111 or a home use television monitor. Since the final broadcast data are usually generated as MPEG-2 data, when the data are reproduced on the display device 240, an MPEG-2 reproducing function is required. On the other hand, when the data are reproduced on the television monitor, a transforming function to transform from MPEG-2 data to NTSC signals is required.

As described above, a timing of reproduction is designated by a user, but the timing can be controlled by the program editing function 430 so that the reproduction is started when the generation of the final broadcast data is completed, or while the program editing function 430 is running. In this invention, even if the reproduction of the final broadcast data and execution of the program editing function are performed simultaneously, the reproduction can be carried out from the beginning of the recorded broadcast data, rather than displaying a real-time (live) broadcast. When the program editing function 430 deletes or shifts, for example, a commercial broadcast part, if reproduction is performed, an advance of the reproduced program may catch up a real-time (live) broadcast.

On the other hand, the server 121 includes a program time information managing function 510, a watching agent managing function 520, and an advertisement providing company managing function 530.

The program time information managing function 510 provides program time information related to the corresponding program, in response to a request from the program time information receiving function 420. The program time information can be provided at a single time if contents of the program time information for all broadcast time are ready when a request is received. However, if a part of the program time information is ready, the program time information can be gradually provided to the program time information receiving function 420 based on a control of the program time information managing function 510.

The contents of the program time information are, in this embodiment, managed by the watching agent managing function 520 and the advertisement providing company managing function 530, as described later.

The watching agent managing function 520 receives, in a predetermined time period, start times and end times of TV programs, and start times and end times of commercial broadcast parts and news broadcast parts of each TV program from a plurality of watching agents 122 who actually watch TV programs. Then, the function 520 decides the start times and the end times in the program time information by selecting proper times from the times received from the agents.

In this embodiment, the plurality of watching agents 122 are adopted to obtain actual data for actual TV broadcast. However, in the future, if the start time and the end time of a specific program and the start times and the end times of the commercial broadcast parts and the news broadcast parts can be given by a new technology or a method, or from a new route, the contents of the program time information can be managed by using the technology, the method, or the route.

It is desirable that the watching agent 122 contracts for providing the time information. The watching agent managing function 520 can receive the time information from the watching agents 122 via the Internet by using a web application running on a personal computer or a mobile phone. As mentioned above, the watching agent managing function 520 finally decides the start times and the end times in the program time information by selecting the most suitable times (in other words, the most reliable times) among the time information received from the plurality of watching agents 122.

For example, when fifty of watching agents 122 provide measured start times of a program, the watching agent managing function 520 can finally decide an average value of the fifty of received start times as a start time. Also, a start time can be decided by averaging the received start times after excluding times of the earliest time group and times of the latest time group from the fifty of received start times, or by selecting a time of the highest frequency among time group distributed in a predetermined range from the average time.

Each of the watching agents 122 can send time information such as the start time, by designating the time itself. Also, the agents 122 can send the time information by simply pushing a specific button, if when the specific button is pushed, a time when the button is pushed is given by a personal computer or a mobile phone and the given time is sent. In this case, it is efficient to subtract a predetermined time from each of the times sent from the watching agents 122, considering that it takes a predetermined time from when the agent watches an actual image to when the agent pushes a button.

Each of the watching agents 122, as described above, uses a personal computer or a mobile phone to send a start time or the like to the server 121. However, in some cases, it may be required to adjust times held by the personal computer and the mobile phone by using a certain method.

Further, the watching agent is not limited to a human being. An automatic determination software or an organization providing the above times may be the watching agent, as far as they can provide a start time and an end time of a program.

The advertisement providing company managing function 530 manages contents, in the program time information, related to destination locations where specific commercial broadcast parts are moved to. In general, destination locations of broadcast parts which are irrelevant to main broadcast parts of a program, such as commercial broadcast parts or news broadcast parts, are denoted by numerical numbers such as “0”, “1”, and “2”. Namely, the non-main broadcast pasts are deleted or moved to specific locations in the latter part. The function 530 manages the commercial broadcast parts so that the commercial broadcast parts which tend to be avoided are kept between the main broadcast parts like a real-time TV broadcast based on a contract with an advertisement providing company 140. Also, the function 530 controls so that even if the commercial broadcast parts are moved to the latter part, a specific commercial broadcast part can be broadcast in a predetermined priority among the commercial broadcast parts moved to the latter part.

For example, as shown in the program time information 600 of FIG. 4, it is assumed that a broadcast part corresponding to a row of No. 4 is a fifteen seconds of commercial broadcast part, a broadcast part corresponding to a row of No. 5 is a two minutes and forty-five seconds of commercial broadcast part, and as a result, both of them collectively form a three minutes of commercial broadcast part.

Herein, it is further assumed that a destination location of the broadcast part corresponding to the row No. 4 is denoted as “1” based on a contract with an advertisement providing company 140, and a destination location of the broadcast part corresponding to the row No. 5 is denoted as “0” with no contract.

In this case, in broadcast data actually to be reproduced in the home site 110, the commercial broadcast part corresponding to the row No. 5 is not included, and only the commercial broadcast part corresponding to the row No. 4 is reproduced immediately after the main broadcast parts. If the destination location of the broadcast part corresponding to the row No. 4 is denoted as “original”, the broadcast part is reproduced in an original location between the main broadcast parts.

An advertisement providing company 140 which originally does not sponsor a program also can provide a commercial broadcast part for the program. In this case, as described above, information including at least one of a still image, a dynamic image, and a voice is provided to the home site 110, wherein the information is recorded in a designated location of broadcast data.

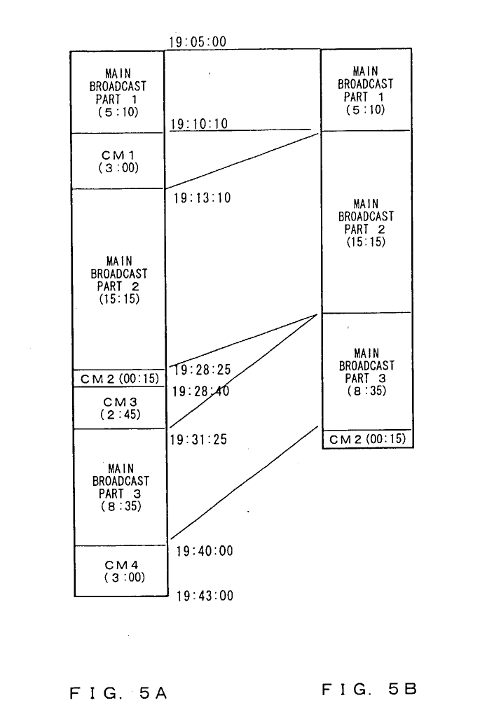

Next, a description is made about a method of editing digital data performed by the program editing function 430 when the program time information 600 shown in FIG. 4 is given, with reference to FIGS. 5A and 5B.

Herein, it is assumed that the digital data include contents of a program of a specific channel corresponding to the program time information 600, from 19:05:00 to 19:43:00.

It is also assumed that editing is performed by using the program time information 600 after recording of the digital data is completed, for the sake of simple explanation. However, if the program time information 600 is sent step by step based on an actual broadcast via a network 130, whenever the program time information is received, the corresponding editing process can be performed.

FIG. 5A shows a time table of digital data temporarily stored by the TV broadcast receiving function 410. Times denoted at the right side of the table represent times when each the corresponding broadcast is performed. Therefore, it is understood that the digital data relates to broadcast performed from 19:05:00 to 19:43:00.

FIG. 5B shows a time table of broadcast data edited by the program editing function 430. The program editing function 430 first interprets the program time information 600 shown in FIG. 4. Since destination locations corresponding to rows No. 1, No. 3, and No.6 are denoted as “original”, the function 430 keeps broadcast parts corresponding to the rows in the digital data in an original broadcast order.

In FIG. 5A, the kept broadcast parts correspond to main broadcast parts 1, 2, and 3, after the editing, the main broadcast parts 1, 2, and 3 are placed continuously as shown in FIG. 5B.

Since the program time information 600 includes a destination location of a row No. 4 denoted as “1”, broadcast part corresponding to the row is placed in the latter part of the broadcast data. Since destination locations of rows No. 2, 5, and 7 are all “0”, broadcast parts corresponding to the rows are deleted, namely are not kept in the broadcast data.

Consequently, as shown in FIG. 5B, for commercial broadcast parts, only a broadcast part of CM2 is inserted after the main broadcast parts 1 to 3, based on a designation in the program time information 600.

In this example, it is recognized that thirty-eight minutes of original broadcast program is shortened to twenty-nine minutes and fifteen seconds of broadcast program, by reorganizing so that the main broadcast parts are moved to the former part and one of the commercial broadcast parts is moved to the latter part. The digital data of FIG. 5A are deleted from a memory or a hard disk after the above editing process. The broadcast data of FIG. 5B are recorded into a proper recording medium such as a hard disk for the sake of a later reproduction.

Also, herein, the final broadcast data of FIG. 5B are arranged in an order of being reproduced, but the same order of reproduction can be realized by managing a start address, a data length, and an order of reproduction of each broadcast part.

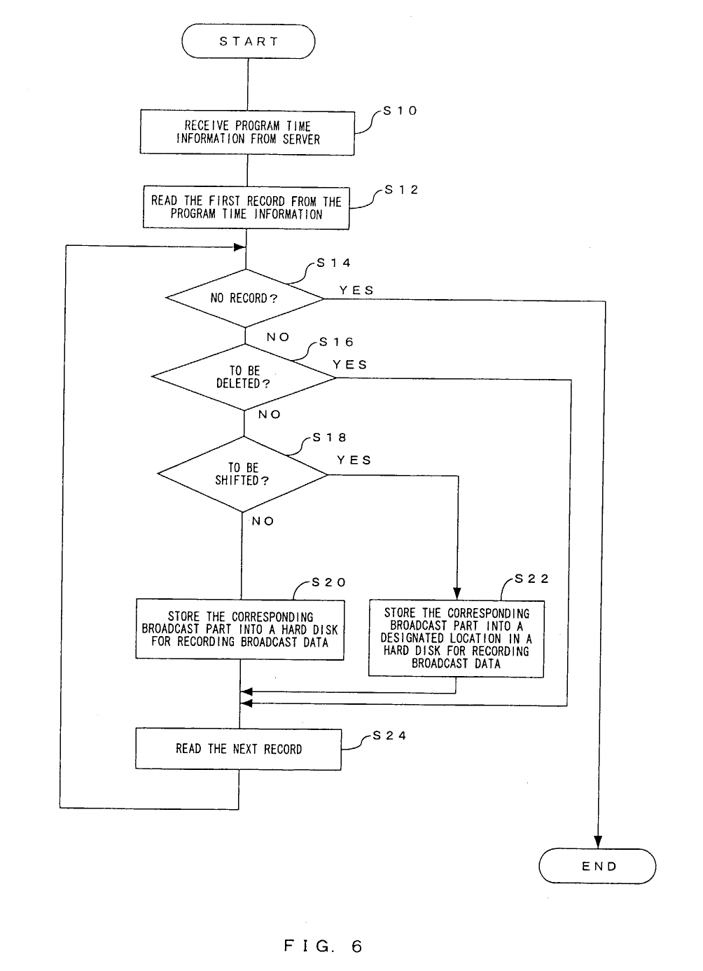

Then, a description is made about an editing process of the program editing function 430 with reference to a flowchart shown in FIG. 6.

Herein, a TV broadcast is once recorded in a memory or a hard disk as digital data by using a timer recording function, after that, the digital data are processed by the editing process and recorded into a hard disk which is prepared for recording broadcast data.

The editing process can be performed simultaneously with recording by a timer recording function, to some extent.

First, in step S10, a program time information 600 corresponding to a program recorded by a timer recording function is received from the server 121. The reception is done by the program time information receiving function 420 as mentioned above. The information 600 includes a plurality of records (rows) as shown in FIG. 4, and each record includes start times and end times of broadcast parts, and destination locations.

Next, in step S12, the first record of the program time information 600 is read out, and in step S14, it is determined whether there is more record to be read or not. If There is no record to be read, the process is terminated.

If the first record exists, the process proceeds to step S16 and then, it is determined whether a broadcast part corresponding to the record must be deleted or not. The determination depends on whether an item destination location in the record is denoted as “0” or not. If the part is to be deleted, no process is done for the broadcast part and in step S24, the next record is read out.

If the part is not to be deleted, it is determined whether the part is to be shifted(moved to) or not in step S18. If the item destination location denoted by a numerical number other than “0”, it is determined that the part is an object of being shifted. If the part is to be shifted, the part (which is specified by a start time and an end time, and composed of digital data) is recorded into a hard disk for recording broadcast data, in step S22. It is required that the broadcast part to be shifted is finally recorded in the broadcast data in an order of the numerical number in the destination location. However, since each of the records in the program time information 600 is not always read in an order of the numerical number in the destination location, it is required that broadcast parts to be shifted are rearranged in the order of the numerical number in the destination location, after all records in the program time information 600 are read.

If it is determined that the broadcast part is not an object to be shifted in step S18, the broadcast part is expected to be “original”, then in step S20, the broadcast part is directly recorded into a hard disk for recording broadcast data.

Thus, a process from step S14 to step S24 is performed for each record, and if the processes is done for all the records, the process is terminated.

Resulting from the process, the broadcast data shown in FIG. 5B are generated. Also, the process shown in FIG. 6 is an example for illustrating the invention. Therefore, the broadcast data can be generated by a variety of other known methods and procedures.

As described above, according to the invention, it is provided a broadcast recording method and a broadcast recording device which can record an extended TV program or a TV program which is moved back due to the extension of the prior TV program.

Further, according to the invention, it is provided a broadcast recording method and a broadcast recording device which, while a TV program is recorded by a timer recording function, can reproduce the TV program being recorded from the beginning.

Still further, by using a method and a device of the invention, it is possible to pick up specific broadcast parts in a TV program and record the picked up parts. For example, in a case of a broadcast of sports, if only scenes connected with a specific player are provided as the program time information 600, an abridged version (a digest form) of broadcast data for the specific player can be easily made in a home.

1. A broadcast recording method comprising the steps of:
receiving a broadcast;
receiving broadcast information which includes a start time and an end time related to at least one broadcast part of a plurality of broadcast parts in the broadcast;
editing the received broadcast by using the broadcast information; and
recording the edited broadcast.

2. The broadcast recording method of claim 1 further comprising the steps of:
generating the broadcast information; and
providing the broadcast information.

3. The broadcast recording method of claim 2, wherein:
the generating step generates the broadcast information based on actual results of the broadcast.

4. The broadcast recording method of claim 3, wherein:
the actual results of the broadcast are provided by a watching agent.

5. The broadcast recording method of claim 1, wherein:
the editing step edits the received broadcast so that a broadcast part specified by a pair of times, the start time and the end time, included in the broadcast information is kept, or the broadcast part is deleted.

6. The broadcast recording method of claim 1, wherein:
the broadcast information further includes locating information comprising an identifier representing whether each broadcast part is to be kept or not, and an order of being recorded;
the editing step edits so as to rearrange each broadcast part based on the locating information.

7. The broadcast recording method of claim 6, wherein:
the locating information is provided based on at least one request of a broadcast advertisement provider.

8. The broadcast recording method of claim 1 further comprising a step of:
reproducing the recorded broadcast.

9. The broadcast recording method of claim 8, wherein:
the reproducing step is executed simultaneously with the step of recording the edited broadcast.

10. A method of providing information related to a broadcast comprising the steps of:
generating broadcast information which includes a start time and an end time related to at least one broadcast part of a plurality of broadcast parts in the broadcast; and
providing the broadcast information.

11. The broadcast recording method of claim 2, wherein:
the broadcast information further includes additional information including at least one of a still image, a dynamic image, and a voice;
the editing step edits so that the additional information is added to the broadcast.

12. A broadcast recording device comprising:
a broadcast receiving unit which receives a broadcast;
a broadcast information receiving unit which receives broadcast information which includes a start time and an end time related to at least one broadcast part of a plurality of broadcast parts in the broadcast;
an editing unit which edits the received broadcast by using the broadcast information; and
a recording unit which records the edited broadcast.

13. A broadcast information providing device comprising:
a generating unit which generates broadcast information which includes a start time and an end time related to at least one broadcast part of a plurality of broadcast parts in the broadcast; and
a providing unit which provides the broadcast information.

14. A computer readable recording medium storing a program performing a method of recording broadcast, the program comprising the steps of:
receiving a broadcast;
receiving broadcast information which includes a start time and an end time related to at least one broadcast part of a plurality of broadcast parts in the broadcast;
editing the received broadcast by using the broadcast information; and
recording the edited broadcast.

15. A computer readable recording medium storing a program performing a method of providing information related to broadcast, the program comprising the steps of:
generating broadcast information which includes a start time and an end time related to at least one broadcast part of a plurality of broadcast parts in the broadcast; and
providing the broadcast information.
